(19) United States
(12) Patent Application Publication
(10) Pub. No.: US 2025/0185837 A1
(43) Pub. Date: Jun. 12, 2025

(54) COFFEE LIQUID EXTRACTION DEVICE

(71) Applicant: Wuxi Huozhong Power Equipment Co., Ltd, Wuxi (CN)

(72) Inventor: Liang CHEN, Wuxi (CN)

(73) Assignee: Wuxi Huozhong Power Equipment Co., Ltd, Wuxi (CN)

(21) Appl. No.: 18/950,212

(22) Filed: Nov. 18, 2024

(30) Foreign Application Priority Data
Dec. 11, 2023 (CN) 202311691023.7

(51) Int. Cl. A47J 31/36; A47J 31/06; A47J 31/44

(52) U.S. Cl. CPC A47J 31/36; A47J 31/0663; A47J 31/4467

(57) ABSTRACT

The present invention discloses a coffee liquid extraction device, comprising: a machine body equipped with a worktable; a portafilter assembly that performs reciprocating motion on the worktable, wherein the portafilter assembly includes two portafilters used for holding coffee grounds; a tamping mechanism disposed above the portafilter assembly and mounted on the machine body, the tamping mechanism being used to compress the coffee grounds within the portafilters; extraction heads mounted on the machine body, comprising two extraction heads that are equally spaced on both sides of the tamping mechanism; the line connecting the center points of the two extraction heads is parallel to the line connecting the center points of the two portafilters; the extraction heads are used to extract the compressed coffee grounds within the portafilters. This coffee liquid extraction device integrates the functions of tamping coffee grounds and extracting coffee liquid.

### TECHNICAL FIELD

The present invention relates to the technical field of coffee liquid extraction, specifically to a coffee liquid extraction device.

### BACKGROUND TECHNOLOGY

In existing coffee liquid extraction methods, it is typically necessary to manually place coffee grounds into a portafilter, then use a separate tamper to level the coffee grounds in the portafilter. Finally, the portafilter containing the tamped coffee grounds is inserted into an extraction machine for coffee liquid extraction. Users need to prepare multiple devices to obtain coffee liquid, which can lead to issues such as occupying excessive space and cumbersome operation. Moreover, current coffee liquid extraction devices can only extract from a single portafilter at a time. When multiple users are involved, they need to queue and wait, which greatly diminishes the user experience.

How to solve the above technical problems has become an urgent technical challenge in the industry.

### SUMMARY OF THE INVENTION

To at least address the aforementioned technical issues, an objective of the present invention is to provide a coffee liquid extraction device that integrates the functions of tamping coffee grounds and extracting coffee liquid.

To achieve the above objective, the coffee liquid extraction device provided in this application includes: a machine body equipped with a worktable; a portafilter assembly that performs reciprocating motion on the worktable; the portafilter assembly includes two portafilters used for holding coffee grounds; a tamping mechanism disposed above the portafilter assembly and mounted on the machine body; the tamping mechanism is used to compress the coffee grounds within the portafilters; extraction heads mounted on the machine body, including two extraction heads equally spaced on both sides of the tamping mechanism; the line connecting the center points of the two extraction heads is parallel to the line connecting the center points of the two portafilters; the extraction heads are used to extract coffee from the compressed coffee grounds within the portafilters.

Further, each portafilter includes: a bowl wall that is vertically movable; a bowl bottom provided with multiple bottom through-holes.

Further, the portafilter assembly also includes: a portafilter through-hole communicating with the bowl bottom through-holes; coffee liquid is discharged from the portafilter assembly through the portafilter through-hole.

Further, the device also includes: a pushing mechanism disposed below the tamping mechanism; the pushing mechanism is used to deliver coffee grounds into the portafilter located beneath the tamping mechanism; the pushing mechanism also includes means for removing coffee grounds residue from the bowl bottom.

Further, the distance between the center points of the two portafilters is equal to the distance from the center point of the extraction heads to the center point of the tamping mechanism.

Further, the worktable is provided with guide rails, and the portafilter assembly performs reciprocating motion on the guide rails; both ends of the worktable are equipped with stoppers to prevent the portafilter assembly from disengaging from the guide rails.

Further, the worktable is provided with at least one through-hole located beneath the extraction heads.

Further, when the through-hole is singular, the worktable also includes a groove; there are two guide rails; the groove is positioned between the two guide rails; the through-hole is situated within the groove.

Further, when the portafilter moves directly beneath an extraction head, the portafilter through-hole aligns and communicates with the through-hole.

Further, the device also includes: a residue storage tank located below the worktable.

In the coffee liquid extraction device of the present application, comprising: a machine body with a worktable; a portafilter assembly that reciprocates on the worktable, including two portafilters for holding coffee grounds; a tamping mechanism above the portafilter assembly, mounted on the machine body, for compressing coffee grounds in the portafilters; extraction heads on the machine body, including two extraction heads equally spaced on both sides of the tamping mechanism; the line connecting the center points of the two extraction heads is parallel to that of the two portafilters; the extraction heads are used to extract coffee from the compressed coffee grounds in the portafilters. This coffee liquid extraction device integrates the functions of tamping coffee grounds and extracting coffee liquid, addressing issues of occupying excessive space and cumbersome operation caused by the need to prepare multiple devices when obtaining coffee liquid. By designing the extraction and tamping mechanisms separately, it avoids the problem where using an extraction head that also functions as a tamper can lead to water droplets pressing into the coffee grounds, causing pits on the surface of the coffee puck and thereby affecting the quality of the coffee liquid. The design of dual extraction heads and dual portafilters greatly reduces user waiting time, enhancing the user experience. The extraction head's water outlet is designed like a showerhead or mesh, increasing the contact area between the coffee puck and hot water for better extraction results.

### BRIEF DESCRIPTION OF THE DRAWINGS

The drawings are provided to offer further understanding of the present application and constitute a part of the specification. They are used to explain the present application together with the embodiments and do not limit the scope of the application. In the drawings:

FIG. 1 is a structural schematic diagram of the coffee liquid extraction device according to an embodiment of the present application.

### REFERENCE NUMERALS

101—Machine body; 102—Worktable; 103—Portafilter assembly; 104—First portafilter; 105—Second portafilter; 106—First extraction head; 107—Second extraction head; 108—Tamping mechanism; 109—Guide rail; 110—Stopper; 111—Residue storage tank.

### DETAILED DESCRIPTION

The embodiments of the present application will be described in more detail below with reference to the accompanying drawings. While certain embodiments of the present application are shown in the drawings, it should be understood that the present application can be implemented in various forms and should not be construed as limited to the embodiments set forth herein. Rather, these embodiments are provided to make the present application more thorough and complete, and to fully convey the scope of the application to those skilled in the art. It should be understood that the accompanying drawings and embodiments are provided for illustrative purposes only and are not intended to limit the scope of protection of the present application.

It should be understood that the various steps described in the method embodiments of the present application can be performed in different orders and/or executed concurrently. In addition, the method embodiments may include additional steps and/or omit the execution of certain steps shown. The scope of the present application is not limited in this regard.

The term “comprising” and its variations as used herein are open-ended terms, meaning “including but not limited to.” The term “based on” means “at least partially based on.” The term “an embodiment” means “at least one embodiment;” the term “another embodiment” means “at least one other embodiment;” the term “some embodiments” means “at least some embodiments.” Relevant definitions of other terms will be provided in the descriptions below.

It should be noted that the modifiers “a,” “an,” and “multiple” mentioned in this application are illustrative and not limiting. Those skilled in the art should understand that unless explicitly stated otherwise in context, they should be understood as “one or more.” “Multiple” should be understood as two or more.

Below, the embodiments of the present application will be described in detail with reference to the accompanying drawings.

An embodiment of the coffee liquid extraction device provided by the present invention includes: a machine body, provided with a worktable on the machine body; a portafilter assembly that performs reciprocating motion on the worktable; the portafilter assembly includes two portafilters used for holding coffee grounds; a tamping mechanism disposed above the portafilter assembly; the tamping mechanism is arranged on the machine body; the tamping mechanism is used to compress the coffee grounds within the portafilters; extraction heads, arranged on the machine body; the extraction heads include two; the two extraction heads are equally spaced on both sides of the tamping mechanism; the line connecting the center points of the two extraction heads is parallel to the line connecting the center points of the two portafilters; the extraction heads are used to extract the compressed coffee grounds within the portafilters.

### Embodiment 1

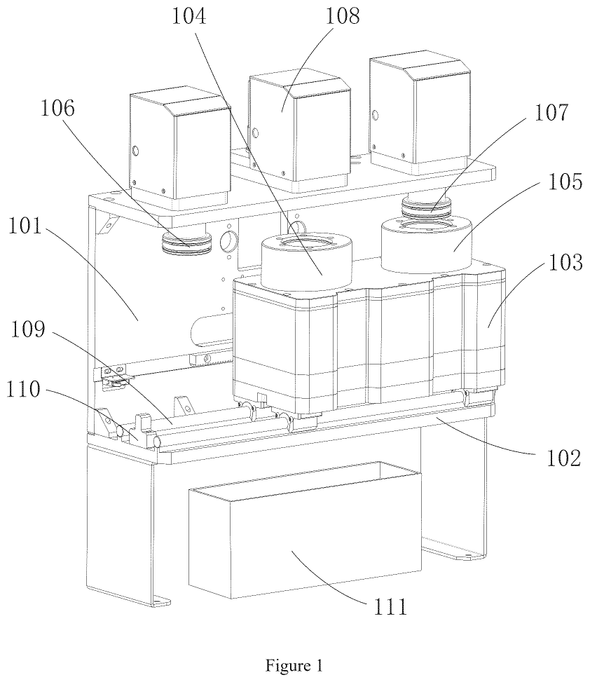

FIG. 1 is a schematic structural diagram of the coffee liquid extraction device according to an embodiment of the present application. Below, with reference to FIG. 1, a detailed description of the coffee liquid extraction device of the embodiment of the present invention is provided.

In an exemplary embodiment, the coffee liquid extraction device of the present application includes: a machine body 101, which can be understood as the carrier or framework for the other components.

In an exemplary embodiment, the machine body 101 is provided with a worktable 102.

In an exemplary embodiment, the worktable 102 is equipped with guide rails 109.

In an exemplary embodiment, the number of guide rails 109 is not less than two as needed; for example, there are two guide rails 109.

In an exemplary embodiment, stoppers 110 are also provided at both ends of the worktable 102; of course, stoppers 110 can also be provided at both ends of the guide rails 109 as needed.

In an exemplary embodiment, the length of the guide rails 109 does not exceed the length of the worktable 102.

In an exemplary embodiment, the stoppers 110 are used to prevent the portafilter assembly 103 from disengaging from the guide rails 109.

In an exemplary embodiment, the coffee liquid extraction device of the present application further includes: a portafilter assembly 103.

In an exemplary embodiment, the portafilter assembly 103 performs reciprocating motion on the worktable 102.

In an exemplary embodiment, the bottom of the portafilter assembly 103 is provided with accessories that match the guide rails 109 on the worktable 102, such as sliders, slide grooves, and so on.

In an exemplary embodiment, the portafilter assembly 103 can perform reciprocating motion on the worktable 102, that is, it can move back and forth on the worktable 102.

In an exemplary embodiment, the portafilter assembly 103 includes portafilters.

In an exemplary embodiment, the portafilters are used to hold coffee grounds; that is, the coffee grounds need to be placed in the portafilter for coffee liquid extraction.

In an exemplary embodiment, each portafilter includes a bowl bottom and a bowl wall.

In an exemplary embodiment, the bowl bottom is provided with multiple bottom through-holes; that is, the bowl bottom has a mesh structure. The mesh structure allows coffee liquid to flow out through the bottom through-holes during subsequent coffee liquid extraction.

In an exemplary embodiment, the size of the bottom through-holes on the bowl bottom and the spacing between multiple bottom through-holes can be set according to the particle size of the coffee grounds to meet the extraction requirements of the coffee liquid. That is, when the coffee grounds are placed in the portafilter, they will not pass through the bowl bottom, or only a very small portion of the coffee grounds will leak through the bowl bottom, and the weight of the leaked coffee grounds can be neglected.

In an exemplary embodiment, the bowl wall is vertically movable.

In an exemplary embodiment, when the bowl wall rises from within the portafilter assembly 103, the bowl wall and the bowl bottom together form the portafilter.

In an exemplary embodiment, after the bowl wall descends, it is hidden within the portafilter assembly 103; that is, when the bowl wall is completely hidden within the portafilter assembly 103, the bowl bottom is exposed on the upper surface of the portafilter assembly 103. That is, the bowl bottom is flush with the upper surface of the portafilter assembly 103, or the bowl bottom is slightly higher than the upper surface of the portafilter assembly 103.

In an exemplary embodiment, optionally, the bowl wall further includes a heating layer, which is used to heat and maintain the temperature of the bowl wall, so that the temperature of the coffee liquid can always be maintained at an optimal state—for example, keeping the coffee liquid at 92° C. to 94° C.

In an exemplary embodiment, the portafilter assembly 103 further includes: a portafilter through-hole.

In an exemplary embodiment, the portafilter through-hole communicates with the bottom through-holes of the bowl bottom.

In an exemplary embodiment, the coffee liquid is discharged from the portafilter assembly 103 through the portafilter through-hole.

In an exemplary embodiment, there are multiple portafilters; for example, not fewer than two portafilters.

In an exemplary embodiment, the portafilters include a first portafilter 104 and a second portafilter 105; that is, two portafilters are provided on the portafilter assembly 103.

In an exemplary embodiment, the line connecting the center points of the first portafilter 104 and the second portafilter 105 is parallel to the guide rails 109.

In an exemplary embodiment, the coffee liquid extraction device of the present application further includes: a tamping mechanism 108.

In an exemplary embodiment, the tamping mechanism 108 is arranged above the portafilter assembly 103.

In an exemplary embodiment, the tamping mechanism 108 is mounted on the machine body 101.

In an exemplary embodiment, the tamping mechanism 108 is used to compress the coffee grounds within the portafilters.

In an exemplary embodiment, the tamping mechanism 108 is equipped with a tamper; the tamping mechanism 108 compresses the coffee grounds inside the portafilter using the tamper.

In an exemplary embodiment, the shape and size of the tamper match those of the portafilter.

In an exemplary embodiment, the lower surface of the tamper is smooth and flat; of course, if necessary, the lower surface of the tamper can also be designed with a concave-convex surface.

In an exemplary embodiment, the downward force of the tamper is approximately 15 kilograms.

In an exemplary embodiment, the purpose of compressing the coffee grounds in the portafilter is to level the coffee grounds and press them into a puck shape; it can be understood that when extracting the coffee liquid, the coffee puck is extracted rather than directly extracting from loose coffee grounds.

In an exemplary embodiment, pressing the coffee grounds into a puck shape is intended to achieve better extraction results.

In an exemplary embodiment, the coffee liquid extraction device of the present application further includes an extraction head.

In an exemplary embodiment, the extraction head is arranged on the side of the tamping mechanism 108, for example, on the left or right side of the tamping mechanism 108.

In an exemplary embodiment, the extraction head is mounted on the machine body 101.

In an exemplary embodiment, the extraction head is used to extract the compressed coffee grounds within the portafilter, that is, to extract the coffee puck.

In an exemplary embodiment, the extraction head is externally connected to water pipelines as needed; the water pipelines are connected to hot water or cold water systems.

In an exemplary embodiment, the extraction head is used to extract the compressed coffee grounds in the portafilter located directly below it.

In an exemplary embodiment, the water outlet of the extraction head is shaped like a showerhead or mesh.

In an exemplary embodiment, there is at least one extraction head; of course, the number of extraction heads can be multiple as needed—for example, two extraction heads.

In an exemplary embodiment, the number of extraction heads is the same as the number of portafilters.

In an exemplary embodiment, the number of extraction heads is an even number, symmetrically arranged on both sides of the tamping mechanism 108.

In an exemplary embodiment, for example, there are two extraction heads and two portafilters.

In an exemplary embodiment, the line connecting the center points of the first portafilter 104 and the second portafilter 105 is parallel to the line connecting the center points of the two extraction heads.

In an exemplary embodiment, the two extraction heads are equally spaced on both sides of the tamping mechanism 108.

In an exemplary embodiment, the distance between the center points of the two portafilters is equal to the distance from the center point of an extraction head to the center point of the tamping mechanism 108; for example, the distance between the center points of the first portafilter 104 and the second portafilter 105 equals the distance from the center point of the first extraction head 106 to the center point of the tamping mechanism 108.

In an exemplary embodiment, the coffee liquid extraction device of the present application further includes a pushing mechanism.

In an exemplary embodiment, the pushing mechanism is arranged below the tamping mechanism 108.

In an exemplary embodiment, the pushing mechanism is mounted on the machine body 101.

In an exemplary embodiment, the pushing mechanism is used to deliver coffee grounds into the portafilter located beneath the tamping mechanism 108.

In an exemplary embodiment, the pushing mechanism also includes means for removing coffee grounds residue from the bowl bottom.

In an exemplary embodiment, for example, when the currently idle portafilter is the first portafilter 104, after raising the bowl wall, the first portafilter 104 moves beneath the tamping mechanism 108. The pushing mechanism delivers the corresponding weight of coffee grounds into the first portafilter 104. Then, the tamping mechanism 108 compresses the coffee grounds in the first portafilter 104 into a coffee puck. Finally, the first portafilter 104 moves below an idle extraction head—for example, it moves beneath the first extraction head 106. The first extraction head 106 performs coffee liquid extraction on the first portafilter 104. After the coffee liquid extraction in the first portafilter 104 is completed, the first portafilter 104 moves beneath the tamping mechanism 108. The bowl wall of the first portafilter 104 descends, exposing the coffee residue on the bowl bottom. The pushing mechanism pushes the coffee residue off the bowl bottom, and the pushed-off coffee residue falls into the residue storage tank 111.

In an exemplary embodiment, when the current portafilters are all in working status—for example, the first portafilter 104 is undergoing coffee liquid extraction beneath the first extraction head 106, and the second portafilter 105 contains coffee residue and is located directly beneath the tamping mechanism 108—the bowl wall of the second portafilter 105 descends. The pushing mechanism pushes off the coffee residue from the bowl bottom of the second portafilter 105. As needed, the second portafilter 105 can continue to receive the corresponding weight of coffee grounds and accept compression by the tamping mechanism 108. Alternatively, if there is no new coffee liquid extraction command, and after the coffee liquid extraction in the first portafilter 104 is completed, the portafilter assembly 103 moves: the first portafilter 104 moves beneath the tamping mechanism 108, and the second portafilter 105 simultaneously moves beneath the second extraction head 107. At this time, the step of pushing off the coffee residue from the bowl bottom is repeated.

In an exemplary embodiment, after the coffee residue is pushed off the bowl bottom by the pushing mechanism, if there is a subsequent coffee extraction command to be executed, the bowl wall rises again. The pushing mechanism repeats the step of delivering coffee grounds, and the tamping mechanism 108 repeats the step of compressing the coffee grounds.

In an exemplary embodiment, the design of the dual portafilters and dual extraction heads achieves synchronization of tamping and extraction, as well as synchronization of extraction and residue removal, greatly saving time in coffee extraction and preparation.

In an exemplary embodiment, the worktable 102 is further provided with a through-hole.

In an exemplary embodiment, the through-hole is located below the extraction head, for example, directly beneath the extraction head.

In an exemplary embodiment, optionally, through-holes are provided directly beneath both the first extraction head 106 and the second extraction head 107 on the worktable 102.

In an exemplary embodiment, of course, as needed, there may be only one through-hole. When there is only one through-hole, the worktable 102 is provided with a groove, for example, arranged between the two guide rails 109. The length of the groove does not exceed that of the guide rails 109, and the through-hole is set within the groove.

In an exemplary embodiment, the groove is connected to the through-hole. After extraction, the coffee liquid from the portafilter enters the groove and then flows out through the through-hole on the worktable 102.

In an exemplary embodiment, when the portafilter moves directly beneath the extraction head, the portafilter through-hole connects with the through-hole on the worktable 102. For example, when through-holes are provided directly beneath both the first extraction head 106 and the second extraction head 107, and the first portafilter 104 moves beneath the first extraction head 106, the portafilter through-hole beneath the first portafilter 104 connects with the through-hole on the worktable 102. When the first extraction head 106 extracts the coffee puck in the first portafilter 104, the extracted coffee liquid flows out through the through-hole on the worktable 102, or it can be understood that the user ultimately obtains the coffee liquid through the through-hole on the worktable 102.

In an exemplary embodiment, when there is only one through-hole on the worktable 102, taking the cooperation of the first extraction head 106 and the first portafilter 104 for coffee extraction as an example, the first extraction head 106 extracts the coffee puck in the first portafilter 104. The coffee liquid flows through the portafilter through-hole into the groove on the worktable 102 and then flows out through the through-hole connected to the groove.

In an exemplary embodiment, optionally, the underside of the machine body 101 further includes a residue storage tank 111. The residue storage tank 111 is located in front of the tamping mechanism 108, that is, when the coffee residue is pushed off the bowl bottom, it falls into the residue storage tank 111.

In an exemplary embodiment, the residue storage tank 111 is located below the worktable 102.

In an exemplary embodiment, optionally, the residue storage tank 111 can also be used to collect falling waste liquid.

Although the embodiments of the present invention are disclosed as above, the content is only the embodiments adopted to facilitate understanding of the present invention and is not intended to limit the present invention. Any technician in the field of the present invention may make any modifications and changes in the form and details of implementation without departing from the spirit and scope disclosed by the present invention. However, the scope of protection of the present invention shall still be subject to the scope defined by the appended claims.

What is claimed is:

1. A coffee liquid extraction apparatus comprising: a machine body provided with a worktable; a portafilter assembly configured to reciprocate on the worktable, the portafilter assembly including two portafilters for holding coffee grounds; a tamping mechanism disposed above the portafilter assembly and mounted on the machine body, the tamping mechanism being configured to compress the coffee grounds within the portafilters; two extraction heads mounted on the machine body, the two extraction heads being equally spaced on opposite sides of the tamping mechanism; wherein a line connecting center points of the two extraction heads is parallel to a line connecting center points of the two portafilters; the extraction heads being configured to extract coffee from the compressed coffee grounds within the portafilters.

2. The coffee liquid extraction apparatus according to claim 1, wherein each portafilter comprises: a bowl wall that is vertically movable; a bowl bottom provided with a plurality of bottom through-holes.

3. The coffee liquid extraction apparatus according to claim 2, wherein the portafilter assembly further comprises: a portafilter through-hole communicating with the bowl bottom through-holes; wherein coffee liquid is discharged from the portafilter assembly through the portafilter through-hole.

4. The coffee liquid extraction apparatus according to claim 3, further comprising: a pushing mechanism disposed below the tamping mechanism; the pushing mechanism configured to deliver coffee grounds into the portafilter located beneath the tamping mechanism; wherein the pushing mechanism further includes means for removing coffee grounds residue from the bowl bottom.

5. The coffee liquid extraction apparatus according to claim 4, wherein a distance between center points of the two portafilters is equal to the distance from the center point of the extraction heads to the center point of the tamping mechanism.

6. The coffee liquid extraction apparatus according to claim 5, wherein: the worktable is provided with guide rails along which the portafilter assembly reciprocates; both ends of the worktable are provided with stoppers to prevent the portafilter assembly from disengaging from the guide rails.

7. The coffee liquid extraction apparatus according to claim 6, wherein the worktable is provided with at least one through-hole located beneath the extraction heads.

8. The coffee liquid extraction apparatus according to claim 7, wherein: when the through-hole is singular, the worktable further comprises a groove; there are two guide rails; the groove is disposed between the two guide rails; the through-hole is located within the groove.

9. The coffee liquid extraction apparatus according to claim 8, wherein when the portafilter moves directly beneath an extraction head, the portafilter through-hole aligns with the through-hole in the worktable.

10. The coffee liquid extraction apparatus according to claim 9, further comprising: a residue storage tank located below the worktable.
